(19) United States
(12) Patent Application Publication
(10) Pub. No.: US 2025/0188375 A1
(43) Pub. Date: Jun. 12, 2025

(54) PROCESS FOR THE PRODUCTION OF HYDROGEN FROM BIOMASS

(71) Applicant: BHYO GmbH, Ludwigshafen (DE)

(72) Inventors: Rolf Klaus Otto SCHMITT, Ludwigshafen (DE); Hubertus Kurt WINKLER, Grainau (DE); Martin KARCH, Heidelberg (DE); Bernd Max BODEIT, Worms (DE); Eric Leon SCHMITT, Ludwigshafen (DE)

(73) Assignee: BHYO GmbH, Ludwigshafen (DE)

(21) Appl. No.: 18/844,441

(22) PCT Filed: Mar. 7, 2023
(86) PCT No.: PCT/EP2023/055660

§ 371 Date: Sep. 6, 2024

(30) Foreign Application Priority Data
Mar. 8, 2022 (DE) 10 2022 105 359.8

(51) Int. Cl. C10J 3/48; B01D 45/16; B01D 47/10; B01D 50/40; B01D 53/00; B01D 53/047; B01D 53/14; C01B 3/16; C01B 3/50; C01B 3/56

(52) U.S. Cl. CPC C10J 3/487; B01D 45/16; B01D 47/10; B01D 50/40; B01D 53/002; B01D 53/047; B01D 53/1493; C01B 3/16; C01B 3/506; C01B 3/56; B01D 2252/103; B01D 2257/504; B01D 2257/7027; B01D 2259/4061; C01B 2203/0283; C01B 2203/043; C01B 2203/046; C01B 2203/0475; C10J 2300/0916

(57) ABSTRACT

A method for producing hydrogen from biomass. For this purpose, the biomass is fed into a fluidized bed reactor, in which the biomass is converted into a flow of products. Solid particles are separated in at least one cyclone. Further solid particles and hydrocarbons are separated in a venturi scrubber. A flow of products is generated in the biodiesel scrubbing, which is fed into a water scrubbing and then to a cooling unit for separation. A flow of products is generated in the high-purification of gas, which is fed into a water gas conversion and CO₂ removal. A flow of products is generated in the gas separation.

### CROSS REFERENCE TO RELATED APPLICATIONS

This application is a 371 National Phase of PCT/EP2023/055660, filed Mar. 7, 2023, which claims priority from German Patent Application No. 10 2022 105 359.8, filed Mar. 8, 2022, both of which are incorporated herein by reference as fully set forth.

### TECHNICAL FIELD

The invention relates to a method for producing hydrogen from biomass.

### BACKGROUND

Hydrogen is an energy-rich gas that can be used, for example, in fuel cells to generate electricity, in combustion engines as a fuel or in the chemical industry as a feedstock.

As an energy carrier, hydrogen is not a primary energy source, but must be produced from primary energy. So-called “green hydrogen” as an energy carrier does not cause any carbon dioxide if it is produced using renewable energies such as wind energy or solar energy. “Biohydrogen” also causes no carbon dioxide in the net balance. At present, however, hydrogen is largely produced from fossil primary energy, mainly by reforming natural gas.

Production by water electrolysis using surplus renewable electricity, which is currently favored under the buzzword “power-to-gas”, is considered relatively inefficient and economically uncompetitive compared to the reforming of natural gas, with practically realized efficiencies of barely over 60%, because sufficiently cheap surplus electricity can actually only be used for a few hours a year.

Biohydrogen is hydrogen that is produced from biomass or by means of living biomass. Hydrogen can be produced from synthesis gas, which is produced by gasifying biomass.

A synthesis gas is a gas mixture which is essentially composed of carbon monoxide and hydrogen and which can be used to synthesize other chemical products. The production of synthesis gas from waste materials from the metallurgical and petrochemical industries is well known. However, there is also an increasing need to obtain synthesis gas from biological reactants, especially as these have a sufficiently high proportion of carbonaceous and hydrogen-containing components due to their organic structure.

The main raw materials used for biomass gasification are agricultural raw materials rich in lignocellulose, as well as residual forest wood, residual wood from processing, waste wood, but also, for example, sewage sludge and green waste such as kitchen and garden waste, grass cuttings, leaves, shrub and tree cuttings, as well as processed residual household waste or “brown garbage can” waste.

The gasification of biomass preferably takes place in a fluidized bed reactor. In such a heated fluidized bed reactor, a gaseous fluid flows through a bed of solids, predominantly sand but also other mineral solid particles such as corundum, whereby a fluidized bed is formed in the form of a fluid-solid suspension. The biological material is continuously fed into this fluidized bed and mainly synthesis gas is released. Such a fluidized bed reactor is disclosed, for example, in EP 2 705 121 B1.

However, the gasification of biomass also releases tar-like substances, aromatic hydrocarbons and unconverted residual carbon (soot), which can severely impair the subsequent process steps and components of the group of systems for treating the hydrogen. If these substances are not removed directly from the synthesis gas stream, they lead to a rapid displacement of the downstream components of the group of systems.

For the tarry components and substances, it has proven useful to consider naphthalene as a representative substance and to use it to purify the synthesis gas stream.

DE 10 2014 221 952 A1 discloses a method for treating coke oven gas in which naphthalene is scrubbed out of the compressed coke oven gas with a suitable liquid in a scrubber, thereby reducing the residual amount of naphthalene remaining in the coke oven gas. This makes it possible to carry out the subsequent processing steps, in particular the scrubbing steps, at a lower temperature without naphthalene condensing out. As a result of the lower temperature, the efficiency of the scrubbing steps is significantly improved.

However, in an unfavorable operating mode, naphthalene sublimates quickly in the scrubbing step, causing the section of the group of systems and the following sections of the group of systems to quickly become clogged. This leads to a system standstill and requires time-consuming removal of the deposits and intensive cleaning of the system components.

Catalytic oxidation, as described for example in DE 10 2007 025 420 B4, offers an alternative. The method for the selective removal of tar substances in synthesis gases using transition metal oxides as transition metal oxide catalysts for the selective oxidation of tar substances in synthesis gases discloses a transition metal oxide catalyst containing vanadium oxide.

The methods described lead to a significant reduction of naphthalene and tar-like substances in the flow of products. However, complete removal cannot be achieved, which can lead to a gradual build-up of the components of the group of systems. Economical operation with recurring shutdowns for cleaning processes is difficult to implement.

In addition, tar-like substances, aromatic hydrocarbons and soot deactivate the catalyst in the water-gas conversion, which is useful for increasing the hydrogen yield, at an unfavorable rate and even at the lowest concentrations. The gas separation yield reacts extremely sensitively to these substances. If even the smallest quantities of these substances enter the gas separation process, the separation of hydrogen from the synthesis gas can only take place in an uneconomical range. This means that both water gas conversion and gas separation require an extremely pure and clean gas stream.

### SUMMARY

The object of the present invention is to provide a method for the production of hydrogen from biomass which ensures the removal of soot, aromatic hydrocarbons and tar-like substances from the flow of products. The method should be able to reliably avoid the described problems caused by tar-like substances, aromatic hydrocarbons and soot. In addition, it should be possible to reliably achieve the required purity and cleanliness of the flow of products for water gas conversion and gas separation. Furthermore, the method should have a high hydrogen yield and be suitable for continuous operation.

According to the invention, this object is ensured by a method for producing hydrogen from biomass as well as an arrangement and a use according to the subsidiary main claims. Preferred variants can be seen from the subclaims, the description and the drawings themselves.

Accordingly, it is intended that the method for producing hydrogen from biomass comprises the following steps:

According to the invention, biomass is fed into a fluidized bed reactor.

In a particularly advantageous variant of the method, feedstock such as grasses, residual wood, landscaping material and also sewage sludge can be processed directly and fed into the fluidized bed reactor as additional biomass to produce synthesis gas.

In a particularly favorable variant of the method, the group of systems also includes a collection point and a storage area for biomass, such as grasses, waste wood and landscaping material.

A prerequisite for feeding into the fluidized bed reactor is the processing of fermentation residues, green waste, garden and agricultural waste and sewage sludge. For this purpose, the biomass is preferably dried and/or pressed so that a water content of less than 20% can be achieved.

Preferably, the biomass prepared by drying and pressing is packaged in the form of compacted pellets.

Ideally, the pellets can be fed into the fluidized bed reactor using a screw conveyor.

In an advantageous variant of the invention, fermentation residues from biogas systems can also be pressed for this purpose. Preferably, this can be done with a belt filter press or a frame filter press or a chamber filter press or a screw press.

According to the invention, the biomass is converted into a flow of products in the fluidized bed reactor, in particular thermally converted.

According to a further development of the method, at least one heating device is provided for heating and for continuously maintaining the thermal conversion at the selected method parameters of the fluidized bed reactor, which has a burner for generating heat.

Advantageously, the burner can be operated with a fuel gas that at least partially contains a biogas produced in the biogas system as a component. Such a biogas usually has a high proportion of methane, which is between 50 and 60% by volume. Other components may include water vapor, oxygen, nitrogen, ammonia, hydrogen and hydrogen sulfide. Due to the high methane content, biogas can therefore also be used as a fuel gas, which has a beneficial effect on the carbon dioxide balance of the process for producing hydrogen.

In principle, the fuel gas can also contain other components. These other components can be natural gas, for example, or part of the synthesis gas produced in the fluidized bed reactor. The fuel gas is then burned by oxidation and the heat generated is used to heat the fluidized bed reactor. At least one heating device is designed to achieve an operating temperature of the reactor between 600 and 1000° C.

In addition, it is also possible to provide at least two heating devices on the fluidized bed reactor. These can then create different temperature zones on the fluidized bed reactor at different housing sections. Based on such an arrangement, at least a first gasification zone can be operated with a gasification temperature of between 600 and 770° C., preferably between 700 and 770° C. A second gasification zone with a second gasification temperature preferably has a temperature between 770 and 1000° C., preferably between 770 and 900° C.

In a particularly preferred variant of the method, additional fluidized bed material can be used to support the thermochemical conversion reactions. This fluidized bed material can preferably be in the form of a specific mineral sand (e.g. dolomite, etc.).

In addition, at least one heating device heats the fluidized bed reactor preferably in an allothermal manner. This means that the procedural processes in the fluidized bed are brought about solely by the external effect of heat, but without causing chemical changes. For this purpose, it is necessary that the heat generated in the burner is fed to the fluidized bed reactor without the hot exhaust gases from the burner entering the fluidized bed reactor in material terms. This can be made possible, for example, by the hot exhaust gases acting on the fluidized bed in the form of a heat exchanger. In addition, baffle plates can also be provided to increase the surface area acting on the fluidized bed.

Biomass is used as a reactant for synthesis gas production. The heating to the first gasification temperature and the heating to the second gasification temperature are both active heating, i.e. heating independent of any reaction heat generated during the production process. Alternatively or additionally, the first fluidized bed region and/or the second fluidized bed region can be heated by supplying an oxygen-containing gas, by supplying a synthesis gas and/or by supplying steam. The fluidized bed itself is divided into two temperature zones, i.e. two fluidized bed regions, whereby the first, lower fluidized bed region is heated to the first gasification temperature and the second, higher fluidized bed region is heated to the higher second gasification temperature. Both the pyrolysis step and the conversion of the remaining, lighter particles and the homogeneous gas phase reactions for the conversion of the initially generated pyrolysis gases can then take place within the fluidized bed.

Ideally, pure oxygen is supplied to the fluidized bed reactor in addition to steam. This advantageously leads to an autothermal energy input during the gasification of biomass in addition to the allothermal heart device. This also increases hydrogen formation and reduces tar formation at the same time.

The advantageous design of the gasification of biomass in a fluidized bed reactor leads to a carbon conversion of approx. 95%. The remaining, unreacted residues, for example soot, aromatic hydrocarbons and tar-like substances, leave the fluidized bed reactor with the synthesis gas and must be separated from the synthesis gas by the complex purification process according to the invention.

According to the invention, solid particles are separated downstream of the fluidized bed reactor in at least one cyclone.

Ideally, the separation of solid particles from the synthesis gas stream takes place in two cyclones.

In a preferred variant of the invention, the solid particles are separated from the synthesis gas stream in a first cyclone and a second cyclone above the tar dew point.

Preferably, the first cyclone is operated at 800° C. and the second cyclone at 400° C.

The first cyclone is preferably used for separating coarse solid particles from the synthesis gas stream.

The second cyclone is preferably operated at 350 to 400° C. and is used to separate the remaining, somewhat finer solid particles that could not be completely separated in the first cyclone due to the higher temperature.

Ideally, a steam generator can be operated between the cyclones to utilize the waste heat from the method to cool the flow of products.

Preferably, a steam generator is operated between the first cyclone and the second cyclone to generate a saturated steam flow with a steam pressure of greater than 25 bar, preferably greater than 30 bar.

In a particularly advantageous variant of the method, the waste heat from the fluidized bed reactor between the cyclones is recovered in the form of a steam flow and used to dry the biomass. This can take place in a belt dryer, for example.

Ideally, the steam can be superheated in a downstream steam superheater, in which the separated solid particles and scrubbed-out hydrocarbons as well as tail gas are burned, before it is fed into the fluidized bed reactor with the addition of oxygen.

According to the invention, the further separation of the remaining solid particles takes place in a venturi scrubber. For this purpose, in the process for producing hydrogen from biomass, a venturi scrubber is arranged after at least one cyclone, which scrubs the solid particles remaining after the cyclone out of the gas stream.

In an alternative variant of the invention, two venturi scrubbers are arranged in series. The removal of solid particles such as soot, but also of tar-like substances, takes place to a much greater extent.

In a favorable embodiment of the process according to the invention, the venturi scrubber is operated as an adiabatic saturator. This means that the scrubbing process takes place without external cooling or heating. The flow of products is loaded with water vapor up to the saturation limit.

Ideally, the venturi scrubber is operated at a temperature of more than 75° C., preferably more than 79° C., in particular more than 82° C., and/or at a temperature of less than 100° C., preferably less than 95° C., in particular less than 90° C.

Preferably, the venturi scrubber is operated above the sublimation conditions of naphthalene, as a representative substance of aromatic hydrocarbons. This ensures trouble-free operation of the scrubber without the occurrence of scrubber displacements.

The venturi scrubber preferably flows into a settling tank in which the different phases separate. The synthesis gas stream is fed to the biodiesel scrubbing. The scrub water is collected in a settling tank in which a partition wall or weir is arranged. The phases separate with increasing residence time in the settling tank. The higher hydrocarbons and tars float on the water and flow over the partition wall into a second area of the settling tank.

The higher hydrocarbons and tars can be discharged for further energy recovery depending on the fill level.

In an advantageous variant, the sedimentation tank is made of glass for visualization of the separation layer.

The water in the first part of the sedimentation tank is fed back into the venturi scrubber in a water circuit via at least one filter. This produces a closed water circuit.

According to the invention, a biodiesel scrubber is operated to produce a flow of products.

Preferably, the flow of products from the venturi scrubber is fed into a scrubbing column. Preferably, the column scrubber is operated in counterflow with a scrubbing oil. This scrubbing oil is ideally a biodiesel and/or tar-based scrubbing oil.

In a particularly preferred variant of the invention, the scrubbing oil is a biodiesel whose main component is fatty acid methyl ester (FAME). Such a biodiesel can be obtained by transesterification of vegetable oils. In comparison with fossil scrubbing oils, biodiesel has virtually no sulphur and also a negligible proportion of other pollutants.

Biodiesel is obtained from vegetable oils. Depending on the local conditions, typical starting materials are, for example, rapeseed, palm, sunflower and soybean oil, from which the corresponding methyl esters are formed. Rapeseed oil methyl ester (RME), which can be produced in large quantities in regions with a temperate climate and is commercially available, is particularly suitable in the context of the invention.

Biodiesel is characterized by a very good absorption capacity, especially for carrying out the scrubbing to remove aromatic hydrocarbons, tar-like substances and naphthalene as a substitute substance. The synthesis gas, as a flow of products, which leaves the venturi scrubber, is brought into contact with the biodiesel in a gas scrubber, whereby the aromatic hydrocarbons, the tar-like substances and the naphthalene are absorbed into the biodiesel. The biodiesel is conveniently added at the top of the scrubber and flows through the scrubber in countercurrent to the synthesis gas. The biodiesel enriched with the aromatic hydrocarbons, the tar-like substances and the naphthalene is drawn off in a lower area of the scrubber and fed to a settling tank.

The favorable design of the biodiesel scrubber leads to an absorption of at least 50%, preferably at least 65%, in particular 80% of the naphthalene or the aromatic and higher hydrocarbons in the biodiesel. This effectively prevents the downstream system components from being contaminated by sublimation of the naphthalene and similar substances.

Ideally, the biodiesel scrubber is operated at a temperature of more than 75° C., preferably of more than 79° C., in particular of more than 82° C. and/or operated at a temperature of less than 100° C., preferably of less than 95° C., in particular of less than 90° C. Advantageously, the scrubbing takes place above the sublimation conditions of naphthalene, whereby relocation of the scrubbing can be favorably avoided and the method can be carried out in continuous operation.

In an advantageous variant of the invention, the biodiesel scrubber is operated at a pressure of more than 1 bar, preferably of more than 3 bar, in particular of more than 5 bar and/or is operated at a pressure of less than 11 bar, preferably of less than 9 bar, in particular of less than 7 bar.

Preferably, the loaded biodiesel is fed into a settling tank. Aromatic hydrocarbons and tar-like substances may settle out. The biodiesel flowing over a partition wall is fed back to the biodiesel scrubber via a filter.

Surprisingly, it was found that biodiesel can be easily regenerated after absorption of aromatic hydrocarbons and tar-like substances at high temperatures, especially at temperatures above 150° C., by stripping with superheated steam and that, in contrast to the use of fossil diesel oils, there is no precipitation of sticky, rubber-like substances. Furthermore, biodiesel is largely biodegradable and has an improved CO₂ balance.

The composition and the chemical and physical properties of biodiesel are described, for example, in the standards DIN EN14214 and ASTM D 6751-07A. These standards refer to the use of biodiesel as a fuel. Against this background, for use as a scrubbing liquid for the absorption of aromatic hydrocarbons, variants of biodiesel can also be used in addition to the standardized types of biodiesel, which may deviate to a certain extent from the standards mentioned.

According to the invention, a water scrubbing is operated to generate a flow of products.

Ideally, the flow of products of the synthesis gas is fed to a water scrubbing in a column scrubber after the biodiesel scrubbing. The synthesis gas flows in countercurrent to the scrub water, whereby the scrub water is preferably sprayed via a distributor device at the top of the column.

In an advantageous variant of the invention, the water scrubbing is operated as direct cooling and cools the flow of products to more than 40° C., preferably to more than 45° C., in particular to more than 50° C., and/or to less than 70° C., preferably to less than 65° C., in particular to less than 60° C.

Preferably, the water for operating the column scrubber is fed into a water circuit. For this purpose, the loaded scrub water is fed into a settling tank for phase separation. After phase separation, the water is returned to the column scrubber via a filter and a cooler. With the help of the cooler, the temperature of the scrub water can be precisely controlled to cool the synthesis gas stream without falling below the sublimation temperature of naphthalene and other aromatic or higher hydrocarbons.

In a particularly advantageous variant of the invention, the naphthalene content in the synthesis gas stream can be determined. This can be done, for example, in a gas chromatograph. In this way, the scrub water temperature can be safely set above the sublimation conditions of naphthalene and at the same time the maximum cooling of the synthesis gas stream can be achieved without risking the relocation of the downstream system components.

At the same time, the loading of the synthesis gas stream with water vapor, which is carried out by the venturi scrubber, is condensed in the scrubbing column. This supports the scrubbing out of the tar-like substances and the naphthalene as a substitute substance. After settling in the settling tank and a filtering process, the water is returned to the venturi scrubber.

The described scrubbing of the synthesis gas stream is always carried out above the sublimation conditions, depending on the naphthalene load. This effectively prevents sublimation and thus displacement of the system components and at the same time produces a gas stream that is as pure as possible for hydrogen production in the gas separation process. The more efficiently the biodiesel scrubbing reduces the naphthalene load of the synthesis gas stream, the cooler the water scrubbing can then be operated.

Advantageously, the water scrubber is operated above the sublimation conditions of naphthalene. The sublimation of naphthalene depends on the temperature, the pressure and the partial pressure of the naphthalene.

The loaded scrub water from the water scrubber is preferably fed into a settling tank equipped with a weir. The phase separation is supported by the stillness in the settling tank. The higher hydrocarbons and the naphthalene float on the water and are separated via the weir.

In a particularly favorable variant, the scrub water is circulated between the venturi scrubber and the water scrubber. The scrubbed-out soot, aromatic hydrocarbons and tarry substances are sludged off in the sedimentation tanks via a partition wall. The finely dissolved substances are removed from the scrub water via filters installed downstream of the settling tanks. The closed water cycle supports the sustainability of the process.

According to the invention, the precipitable residues remaining in the flow of products are separated in a cooling unit to produce a flow of products.

Advantageously, aromatic hydrocarbons, tarry substances and naphthalene are separated in the cooling unit at a temperature of less than 15° C., preferably less than 10° C., in particular less than 5° C. The separated substances are collected in a separator tank and fed for further energy recovery.

In a favorable variant of the invention, the sedimentation tanks can be desludged. The soot, the tar-like substances and the aromatic hydrocarbons with the separations of the cyclones are fed to an energy recovery process, for example incineration. This can preferably take place in the heating device of the fluidized bed reactor and/or in a steam generator. As a result, all carbon-containing components fed into the system are fully utilized for energy.

Comprehensive and holistic purification using the three scrubbings and cold precipitation ensures the safe operation of the process and group of systems for the production of hydrogen from biomass. Ideally, a large proportion of substances and compounds that can act as catalyst poisons in gas separation, such as sulphur, chlorine, HCN, etc., are also scrubbed out in the process.

The purified synthesis gas is compressed in several compressor stages to the pressure required for gas separation. Radial compressors and/or screw or piston compressors can be used, for example.

In a favorable variant of the invention, three compressors are connected in series, whereby the synthesis gas is compressed to a pressure of more than 12 bar, preferably more than 15 bar, in particular more than 18 bar.

According to the invention, the compressed synthesis gas stream is fed to a fine gas purification system.

Ideally, the remaining sulphur components are adsorbed in a zinc oxide bed in a first step of the fine gas purification process.

In an advantageous variant, the fine gas purification comprises several beds with different bed sizes for the adsorption of trace substances, which can be unfavorable for gas separation.

According to the invention, the water-gas conversion is operated to produce a flow of products. The CO in the synthesis gas stream is converted to CO₂ and H₂ with the addition of steam.

The water-gas conversion reaction is an exothermic equilibrium reaction and can be optimized, for example, through targeted temperature control in a microreactor.

With the addition of water vapor, the CO reacts exothermically to form CO₂ and H₂. The reaction preferably takes place on a catalyst (e.g. iron, Cu/Zn, Co/Mo) at approx. 250-450° C. At higher temperatures, the kinetics are fast but the chemical equilibrium is unfavorable. At low temperatures, the equilibrium is stronger on the product side, but the kinetics decrease. In a favorable variant, the water-gas conversion can be carried out in two stages in a high-temperature and low-temperature stage. The CO content can thus be reduced to 0.6 to 1.5% by volume, depending on how the reactor is operated.

According to the invention, CO₂ is removed from the synthesis gas stream to produce a flow of products for gas separation.

The CO₂ removal can take place adsorptively on a bed filling or selectively on a membrane.

According to the invention, gas separation takes place to produce a pure hydrogen stream.

Ideally, the gas separation can be designed as pressure swing adsorption and/or as a membrane process.

Advantageously, the method for producing hydrogen from biomass is CO₂ neutral. Only the CO₂ of the biomass is emitted. In a favorable variant of the invention, the CO₂ of the biomass is separated. This means that the CO₂ from the CO₂ removal can either be fed to a carbon storage facility or to a further material use, for example in the form of carbonic acid. As a result, the method according to the invention has a clearly negative CO₂ balance. This means that the method for producing hydrogen from biomass is designed as a CO₂ sink.

The residual gas from the gas separation can preferably be fed to the heating device of the reactor or the steam generation unit in the form of a tail gas. The previous CO₂ removal leads to a higher calorific value of the tail gas.

Advantageously, the system network also includes a storage capacity for hydrogen, possibly a connection to a hydrogen network, and a hydrogen filling station for motor vehicles.

The described group of systems or system is used to carry out a method for the production of hydrogen from biomass.

### BRIEF DESCRIPTIONS OF THE DRAWINGS

Further advantages and features of the invention are apparent from the description, from an embodiment example with reference to drawings and from the drawings themselves.

This shows

FIG. 1 a schematic representation of biomass gasification,

FIG. 2 a schematic representation of the gas scrubbers,

FIG. 3 a schematic representation of the gas separation.

### DETAILED DESCRIPTION

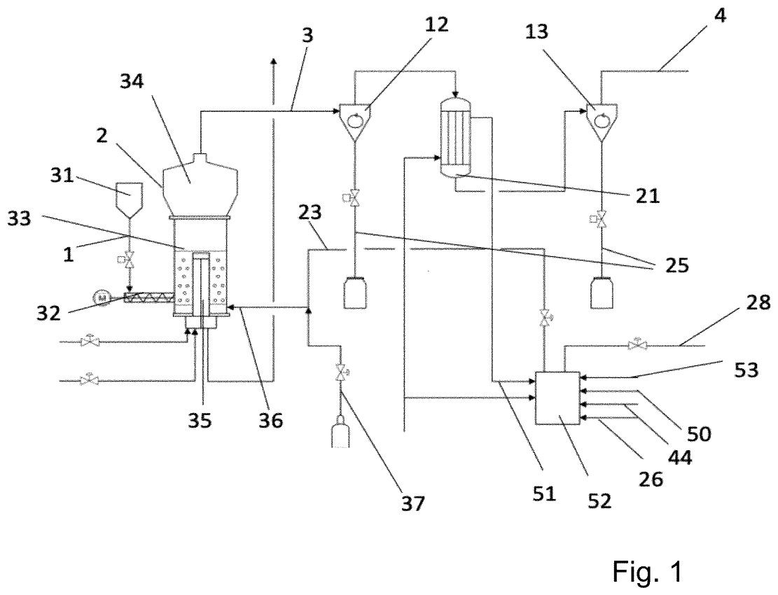

FIG. 1 shows a schematic representation of biomass gasification. The biomass 1 is stored in a storage container 31 and is fed into the fluidized bed reactor 2 in granulated form via a screw conveyor.

In this embodiment, the reactor housing of the fluidized bed reactor 2 is functionally divided into three housing sections. The first, deep-lying fluidized bed housing section serves to accommodate a first, deep-lying fluidized bed region of a fluidized bed of the fluidized bed reactor 2. Sand can be used as the fluidized bed material.

An upper phase boundary of the fluidized bed is approximately at the level of an upper boundary of the second reactor housing section 33. Above the second reactor housing section with a second fluidized bed region, the fluidized bed reactor 2 has the degassing housing section 34 with an enlarged cross-section.

The first heating device 35 in the form of a jacketed tube heat exchanger, which is completely covered by the fluidized bed, heats the lower fluidized bed area to a first gasification temperature in the range between 600° C. and 770° C. The heating device 35 has a heating unit designed as a heat exchanger in the form of a burner and a further heating unit in the form of a feed unit for oxygen-containing and/or vapor-containing gas.

In the embodiment example according to FIG. 1, a flow of products 23 of superheated saturated steam and/or air and/or oxygen is fed to the lower fluidized bed area via the feed unit 36. The flow of products 23 is fed in the area of the bottom of the reactor housing via a large number of nozzles.

A second heating device heats the upper fluidized bed region, above the second reactor housing section 33, to a second gasification temperature which is higher than the first gasification temperature. The second gasification temperature is in the range between 770° C. and 1000° C. and in particular in the range between 770° C. and 900° C. or in the range between 770° C. and 810° C.

As the first gasification temperature is lower than an ash softening or biomass softening temperature, agglomeration of ash or biomass is reduced or even completely prevented during the first gasification step. Pyrolysis takes place in the first fluidized bed area, whereby around 50% to 80% of the biomass is gasified. During pyrolysis in the upper gasification area, lighter biomass particles that have not yet been fully converted are gasified at a sufficient conversion rate due to the higher second gasification temperature and the additional oxygen input.

The biomass 1 converted in the fluidized bed reactor 2 is converted into a flow of products 3. Flow of products 3 essentially comprises a high proportion of synthesis gas, but also proportions of soot, tarry substances and aromatic hydrocarbons as well as naphthalene.

The flow of products 3 is fed to the cyclone 12 to separate coarse solid particles 25, such as soot and incompletely converted biomass fragments. In this design example, the cyclone 12 is operated at approx. 800° C. The flow of products 3 is fed to a steam generator 21, whereby the flow of products 3 is cooled to approx. 400° C. with energy utilization and a saturated steam flow 51 is generated at approx. 25-30 bar. The steam generator 21 can additionally have a steam drum, which comprises a supply of demineralized water, so that the steam generator 21 can be operated in natural circulation.

The saturated steam stream 51 is fed to a steam superheater 52, which is operated with the solid particles 25 and 50, with the liquid hydrocarbons 26 and 44 and with a tail gas and/or a natural gas stream 53. In the steam superheater 52, the saturated steam stream 51 is converted to a superheated saturated steam stream 23, which can have a temperature of up to 450-500° C. In addition, a superheated steam stream 28 with a temperature in the range of 250° C. is generated, which is fed to water gas conversion 19 and CO₂ removal 29.

In this embodiment, an oxygen stream 37 is fed to the superheated saturated steam stream 23 and fed into the fluidized bed reactor 2 via the feed unit 36.

The 400° C. hot flow of products 3 is fed to the cyclone 13, where further, finer solid particles 25 are separated and a flow of products 4 is formed. The solid particles 25 are collected and sent for energy recovery, for example to a burner of the steam superheater 52.

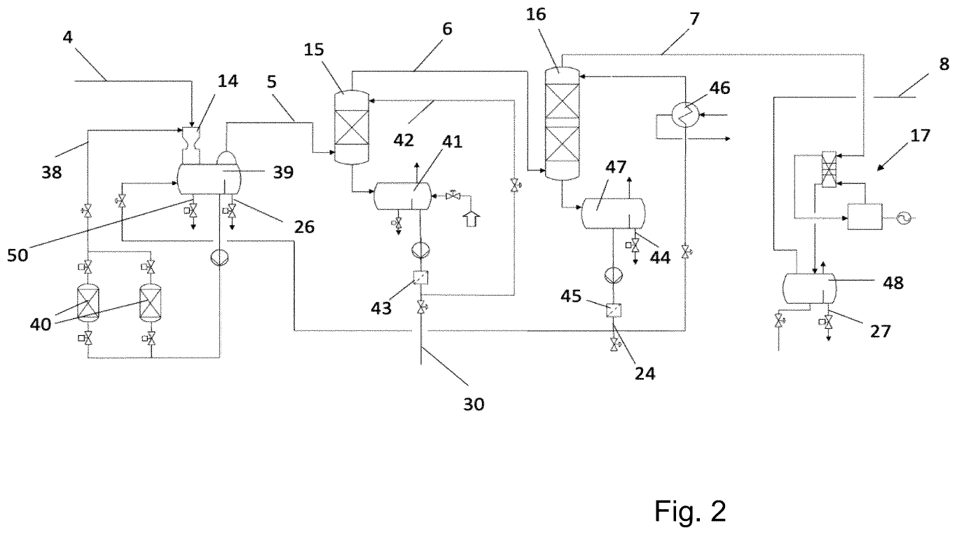

In FIG. 2, the flow of products 4 is brought into intensive contact with a water flow 38 in a venturi scrubber 14 in order to generate a flow of products 5 and to settle a flow of products 26 of hydrocarbons, for example tarry components and naphthalene, as well as to settle solid particles 50. In this design example, the venturi scrubber is designed as an adiabatic saturator and is directly connected to the settling tank 39, in which the water flow 38 is separated from the flow of products 26 and from the solid particles 50. In the settling tank 39, coarse solid particles 50 sink to the bottom, while liquid hydrocarbons float to the top and are collected in a second chamber of the settling tank 39 via a separating plate in the form of a weir. The solid particles 50 can be removed discontinuously.

The flow of products 5 is completely loaded with water in the venturi scrubber 14. Due to the operating mode of the venturi scrubber, the flow of products has a temperature of 80 to 85° C. The flow of products 26 consisting of liquid hydrocarbons and the solid particles 50 are fed to an energy recovery system, for example in the steam superheater 51. The flow of water 38 is fed from the settling tank 39 via alternately operated filters 40 back to the venturi scrubber for further removal of solid particles.

To produce a flow of products 6, the flow of products 5 is separated from a flow of products 30 in the biodiesel scrubber 15. The flow of products 30 essentially consists of naphthalene and aromatic hydrocarbons. Biodiesel has a favorable dissolving capacity for naphthalene and aromatic hydrocarbons and can separate up to 80% of them from the flow of products 5. In this embodiment, the biodiesel scrubber 15 is operated at 85° C. and 1.3 bar, whereby naphthalene can be dissolved in biodiesel before it sublimates and can lead to a transfer to the other system components.

The biodiesel stream 42 is recirculated from the biodiesel scrubber 15 via a settling tank 41 and a filter 43 back to the biodiesel scrubber 15. Settleable substances can sediment in the settling tank 41 and be sludged off.

The flow of products 6 is fed to the column scrubber 16 to generate a flow of products 7. The column scrubber 16 is designed as a direct cooling system. Here, the scrub water 24 is circulated via the settling tank 47, the filter 45 and the cooler 46 to the column scrubber 16. In the cooler 46, the cooling water temperature is set so that the naphthalene in the scrubbing column 16 does not fall below the sublimation conditions. The remaining naphthalene in the flow of products 6 is absorbed in the scrub water 24 at approx. 40 to 55° C. In the settling tank 47, a flow of products 44, which essentially consists of naphthalene and aromatic hydrocarbons, is separated from the scrub water 24 and fed to an energy recovery system.

The flow of products 7 is separated from the hydrocarbons 27 remaining after the scrubbings in the cooling unit 17. For this purpose, the flow of products is cooled to below 10° C. and fed into the separator tank 48, where the hydrocarbons 27 are separated from the flow of products 8. The hydrocarbons 27 are fed to an energy recovery system.

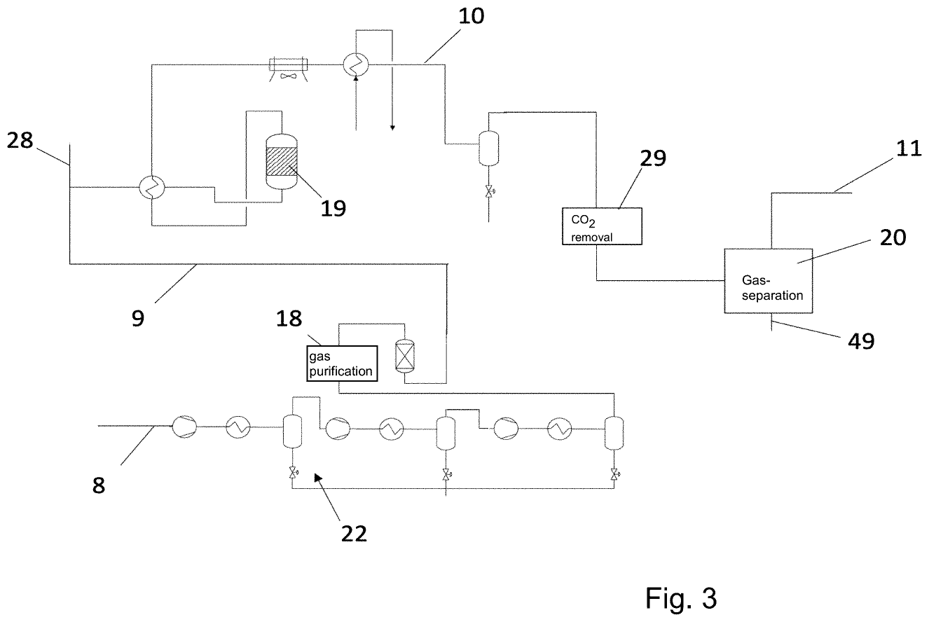

The flow of products 8 in FIG. 3 is compressed to approx. 18 bar in a compressor arrangement 22 and fed to the fine gas purification system 18. In this embodiment, sulphur and sulphur-containing compounds are adsorbed on a ZnO bed and further trace substances are removed in an activated carbon bed, so that the flow of products 9 leaves the fine gas purification system.

The purified and compressed flow of products 9 is fed into the water gas conversion 19 with a flow of products of superheated steam 28. The CO from flow of products 9 reacts exothermically to form CO₂ and H₂. In this embodiment, the reaction takes place on a catalyst (e.g. iron, Cu/Zn, Co/Mo) at approx. 250-450° C.

After the water gas conversion, the resulting flow of products 10 is passed through several coolers for CO₂ removal 29. In this embodiment example, a mixed matrix membrane based on metal-organic framework compounds is used to separate the CO₂ from the flow of products 10. In this embodiment, the separated CO₂ is processed as carbonic acid.

The flow of products 10 is then separated into a hydrogen flow 11 and a tail gas flow 49 in a gas separation 20. For this purpose, the gas separation 20 is designed as pressure swing adsorption with five separate adsorption beds. The tail gas stream 49 is fed to the heating device 35. The stream 11 of pure hydrogen is fed to a hydrogen storage tank and distributed from there.

1. A method for producing hydrogen from biomass (1), the method comprising
feeding the biomass (1) into a fluidized bed reactor (2),
converting the biomass (1) into a first flow of products (3),
separating solid particles (25) in at least one cyclone (12, 13) to produce a second flow of products (4),
separating hydrocarbons (26) and solid particles (50) in a venturi scrubber (14) to produce a third flow of products (5),
scrubbing biodiesel (15) to produce a fourth flow of products (6),
scrubbing water (16) to produce a fifth flow of products (7),
separating the fifth flow of products (7) in a cooling unit (17) to produce a sixth flow of products (8),
high-purifying of gas (18) to produce a seventh flow of products (9),
converting water gas (19) to produce an eighth flow of products (10),
removing CO₂ from the eighth flow of products (10),
separating gas (20) to produce a ninth flow of products (11).

2. The method according to claim 1, wherein separating the solid particles (25) takes place in a first cyclone (12) and a second cyclone (13) above a tar dew point.

3. The method according to claim 1, wherein the venturi scrubber (14) is operated as an adiabatic saturator.

4. The method according to claim 1, wherein the scrubbing of the biodiesel (15) is operated at a temperature of more than 75° C., and is operated at a temperature of less than 100° C.

5. The method according to claim 1, wherein the scrubbing of the biodiesel (15) is operated at a pressure of more than 1 bar, and is operated at a pressure of less than 11 bar.

6. The method according to claim 1, wherein the scrubbing of the water (16) is operated as direct cooling and cools the fifth flow of products (7) to more than 40° C., and to less than 70° C.

7. The method according to claim 1, wherein the scrubbing of the water (16) is operated above sublimation conditions of naphthalene.

8. The method according to claim 1, wherein further hydrocarbons (27) are separated in the cooling unit (17) at a temperature of less than 15° C.

9. The method according to claim 1, wherein the scrub water (24) is circulated between the venturi scrubber (14) and the water scrubbing (16).

10. The method according to claim 1, further comprising operating a steam generator (21) between the first cyclone (12) and the second cyclone (13) with the first flow of products (3) to produce a saturated steam flow (51).

11. The method according to claim 1, wherein the separated CO₂ of the CO₂ removal (29) is fed to a carbon storage tank.

12. A group of systems for carrying out the method according to claims 1.

13. (canceled).
